(19) United States
(12) Patent Application Publication
(10) Pub. No.: US 2008/0120709 A1
(43) Pub. Date: May 22, 2008

(54) Management interface between embedded systems and computer system medium using the same

(75) Inventor: Shih-Chiang Chung, Taipei County (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 11/826,573

(22) Filed: Jul. 17, 2007

(30) Foreign Application Priority Data
Nov. 22, 2006 (TW) 095143250

(51) Int. Cl. H04L 9/32

(52) U.S. Cl. 726/6

(57) ABSTRACT

A management interface between embedded systems of a blade server for executing a management method is provided. The management method comprises receiving a login information from a first system and generating a session ID in response to the login information, wherein the login information has a markup language format; receiving a command information from the first system and sending back an execution result of the command information in response to the command information, wherein the execution result has the markup language format; and receiving a logout information from the first system and removing the session ID in response to the logout information so as to invalidate the session ID, wherein the logout information has the markup language format.

This application claims the benefit of Taiwan application Serial No. 95143250, filed Nov. 22, 2006, the subject matter of which is incorporated herein by reference.

### BACKGROUND OF THE INVENTION

1. Field of the Invention

The invention relates in general to a management protocol between embedded systems, and more particularly to communication and management protocol between modules of a blade server.

2. Description of the Related Art

Embedded systems of a blade server communicate with each other via a hardware channel of a middle plane in the chassis of the blade server. In the following description, a switch blade and a modular management blade (MMB) of the blade server are exemplified to communicate with each other via a series port RS-232 for illustration. In the communication operation of the conventional MMB and switch blade, the MMB executes a self-edited communication management program to command the switch blade by simulating as a user manager so as to control the setting, backup and storing operations of the switch blade. However, the conventional MMB and switch blade have the following problems in communication.

When the series port is transmitting data, it happens very often that some data is transmitted with the wrong characters or omitted in transmission, which results in an operational error of the MMB and switch blade due to error reception. Besides, owing that the MMB gives commands by stimulating as a user manager, the information sent back by the switch blade has also a character pattern easily distinguished by the user manager. However, in terms of the MMB, information of the character pattern has a problem of not being easy to be distinguished.

In addition, different manufacturers will manufacture different interfaces of switch blade. The communication management program executed by the MMB should be compatible to the different interfaces of switch blade. As a result, the communication management program of the MMB is more difficult to be developed and maintained.

### SUMMARY OF THE INVENTION

The invention is directed to a computer system medium with a management interface between embedded systems. The computer system medium has advantages of a low error data transmission rate, easier information discrimination, easier maintenance of the communication management programs and interface unification.

According to a first aspect of the present invention, a management interface between embedded systems of a blade server for executing a management method is provided. The management method comprises receiving a login information from a first system and generating a session ID in response to the login information, wherein the login information has a markup language format; receiving a command information from the first system and sending back an execution result of the command information in response to the command information, wherein the execution result has the markup language format; and receiving a logout information from the first system and removing the session ID in response to the logout information so as to invalidate the session ID, wherein the logout information has the markup language format.

According to a second aspect of the present invention, a computer system medium is provided. The computer system medium has a management interface between embedded systems of a blade server to execute a management method. The management method comprises receiving a login information from a first system and generating a session ID in response to the login information, wherein the login information has a markup language format; receiving a command information from the first system and outputting a device information of a second system corresponding to the command information in response to the command information, wherein the command information has the markup language format; and receiving a logout information from the first system and removing the session ID in response to the logout information so as to invalidate the session ID, wherein the logout information has the markup language format.

The invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a blade server with management protocol between embedded systems according to a preferred embodiment of the invention.

FIG. 2 is an operational diagram of the management interface between the embedded systems according to a preferred embodiment of the invention.

### DETAILED DESCRIPTION OF THE INVENTION

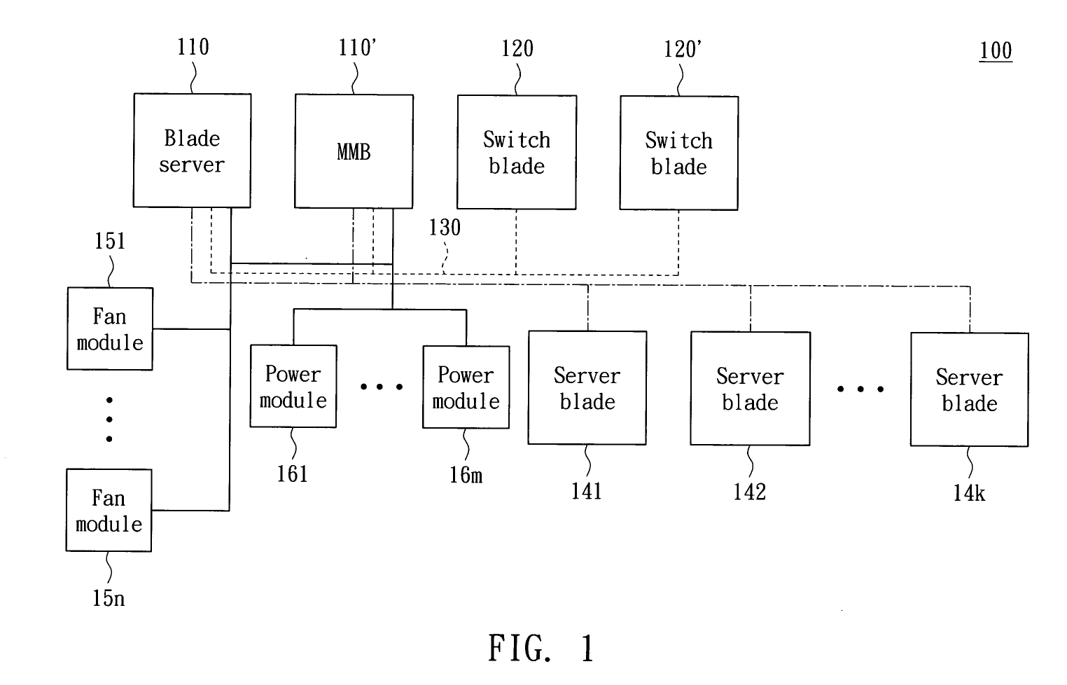

Referring to FIG. 1, a block diagram of a blade server with management protocol between embedded systems according to a preferred embodiment of the invention is shown. A blade server 100 includes a MMB 110 and a switch blade 120. In the embodiment, the MMB 110 is exemplified to be connected to the switch blade 120 via a RS-232 series port 130 and perform management on the switch blade 120 via the management protocol between the embedded systems.

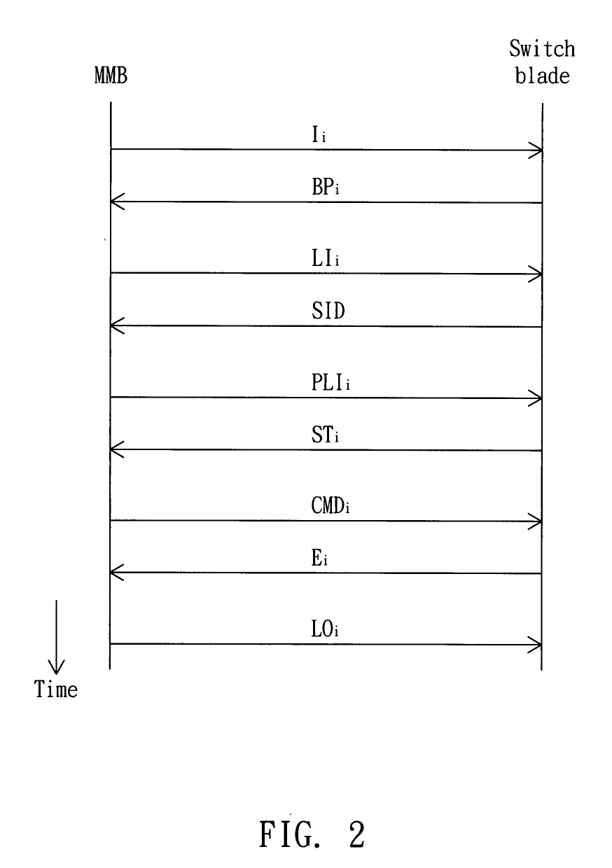

Referring to FIG. 2, an operational diagram of the management interface between the embedded systems according to a preferred embodiment of the invention is shown. First, when the MMB 110 is to obtain an authority of accessing device information of the switch blade 120, the MMB 110 generates and outputs login information Lli to login the switch blade 120. The login information Lli has a markup language format. The switch blade 120 receives the login information Lli and generates a session ID SID in response to the login information Lli.

Next, when the MMB 110 is to access the device information of the switch blade 120, the MMB 110 generates and outputs command information CMDi to control the switch blade 120 to execute an access operation. The command information CMDi has a markup language format. The switch blade 120 receives the command information CMDi and outputs an execution result Ei of executing the command information CMDi.

Following that, when the MMB 110 is to stop performing the access operation on the switch blade 120, the MMB 110 generates and outputs logout information LOi to logout the switch blade 120. The logout information has the markup language format. The MMB 120 receives the logout information LOi and invalidates the session ID SID in response to the logout information LOi.

The data structure of the login information Lli includes two columns respectively including name information and identification password information corresponding to the name information. The switch blade 120 determines an operational authority of the MMB 110 according to the name information and identification password information to provide the corresponding session ID SID. The following program is an operational embodiment to illustrate that the MMB 110 outputs the login information Lli and the switch blade 120 outputs the session ID SID in response to the login information Lli. The markup language is an extensive markup language (XML) for instance.

```
<?xml version=’ 1.0’ ?>
<MODULE_LOGIN>
    <REQUEST>
        <MAXOUTPUTLEN>0x0fff</MAXOUTPUTLEN>
        <USERNAME>admin</USERNAME>
        <PASSWORD>admin</PASSWORD>
    </REQUEST>
</MODULE_LOGIN>
<?xml version=’ 1.0’ ?><?RMCXML version=’ 1.0’ ?>
<MODULE_LOGIN>
    <RC>0x0</RC>
    <OUTPUTLEN>0x0</OUTPUTLEN>
    <SID>0xbc26c2fc</SID>
    <STATENAME>MODULE_RC_OK</STATENAME>
    <CMDOUTPUT></CMDOUTPUT>
</MODULE_LOGIN>
```

All the above request markups are included in the markup <MODULE_LOGIN>. The markup <MAXOUTPUTLEN> includes information representing an upper limit of acceptable information length of the MMB 110. The markups <USERNAME> AND <PASSWORD> respectively include name information and identification password information, which are substantially equal in the embodiment. The markup <RC> includes a return code and the markup <STATENAME> is for representing a present login situation of the MMB 110. In the embodiment, the return code is 0x0 which represents the MMB 110 logins successfully.

The command information CMDi has a data structure with two columns respectively including the session ID SID and a control command. The switch blade 120 determines whether the MMB 110 has an authority of executing the control command according to the session ID SID. The following program is an operational embodiment in which the MMB 110 outputs the command information CMDi and the switch blade 120 outputs the execution result information Ei in response to the command information CMDi.

```
<?xml version=’ 1.0 ?>
<REQUEST>
    <SID>0Xxxxxxxxx</SID>
    <CMDINPUT>getipaddr</CMDINPUT>
    <MAXOUTPUTLEN>0x0fff</MAXOUTPUTLEN>
</REQUEST>
<?xml version=’ 1.0’ ?>
<RESPONSE>
    <RC>0x0</RC>
    <OUTPUTLEN>0X5f</OUTPUTLEN>
    <CMDOUTPUT>
        <IPADDR>192.168.0.1<IPADDR>
        <IPMASK>255.255.255.0</IPMASK>
        <GATEWAY>192.168.0.254</GATEWAY>
    </CMDOUTPUT>
</RESPONSE>
```

The above markup <CMDINTPUT> includes the control command of the command information, which is substantially equal to getipaddr for obtaining IP information of the switch blade 120 in the embodiment. The markup <CMDOUTPUT> includes markups <IPADDRD>, <IPMASK> and <GATEWAY>, which respectively include an IP address, an internet mask and a communication gate of the switch blade 120. The switch blade 120 sends back the return code 0x0 to represent that the control command is executed successfully as executing the control command of the markup <CMDINPUT>.

The data structure of the logout information LOi includes two columns respectively including the session ID SID and a logout command. The switch blade 120 removes the session ID SID to invalidate the session ID according to the logout command. The following program is an operational embodiment in which the MMB 110 outputs the logout information LOi and the switch blade 120 removes the session ID SID in response to the logout information LOi.

```
<?xml version=’ 1.0’ ?>
<MODULE_LOGOUT>
    <REQUEST>
        <SID>0xXXXXXXXX</SID>
        <MAXOUTPUTLEN>0x0fff</MAXOUTPUTLEN>
        <CMDINPUT>MODULELOGOUT</CMDINPUT>
    </REQUEST>
</MODULE_LOGOUT>
<?xml version=’1.0’?>
<MODULE_LOGOUT>
    <RESPONSE>
        <OUTPUTLEN>0xXXXX</OUTPUTLEN>
        <RC>0x0</RC>
        <SID>0xXXXXXXXX</SID>
    </RESPONSE>
</MODULE_LOGOUT>
```

The above markup <CMDINPUT> includes a command MODULELOGOUT and the switch blade 120 removes the session ID SID included in the markup <SID> according to the command MODULELOGOUT. The switch blade 120 sends back the return code 0x0 representing the MMB 110 logins successfully after successfully removing the session ID SID.

In the embodiment, the MMB 110 can output inquiry information Ii to inquire basic parameter information BPi of the switch blade 120 before logging in the switch blade 120 and output post-login information PLli to detect whether the session ID SID is still valid after obtaining the session ID SID. In the following description, a detailed operation is given that the MMB 110 outputs the inquiry information Ii and post-login information PLli.

When the MMB 110 has not obtained the session ID SID and is to obtain basic parameter information BPi such as hardware type and version, and protocol type and version of the switch blade 120 in order to determine whether the above operation can be performed on the switch blade 120, the MMB 110 generates and outputs the inquiry information Ii to inquire the basic parameter information of the switch blade 120. The switch blade 120 receives and outputs the basic parameter information BPi in response to the inquiry information Ii. The following program is an operational embodiment in which the switch blade 120 outputs the basic information BPi in response to the inquiry information Ii.

```
<?xml version=’1.0’?>
<MODULE_DISCOVER>
    <REQUEST>
        <CMDINPUT>MODULEDISCOVER</CMDINPUT>
        <MAXOUTPUT> 0x0fff</MAXOUTPUT>
    </REQUEST>
</MODULE_DISCOVER>
<?xml version=’1.0’?>
<MODULE_DISCOVER>
    <RESPONSE>
        <RC>0x0</RC>
        <OUTPUTLEN>0xXXXX</OUTPUTLEN>
        <ENDPOINTTYPE>Switch Blade</ENDPOINTTYPE>
        <ENDPOINTVERSION>1.0</ENDPOINTVERSION>
        <PROTOCOLTYPE>XML</PROTOCOLTYPE>
        <PROTOCOLVER>1.0</PROTOCOLVER>
    </RESPONSE>
</MODULE_DISCOVER>
```

The above markups <ENDPOINTVERSION>, <ENDPOINTTYPE>, <PROTOCOLTYPE> and <PROTOCOLVER> are all included in the markup <RESPONSE> of the MMB 110 and respectively include the hardware type, hardware version, protocol type and protocol version of the switch blade 120. The MMB 110 determines whether the switch blade 120 can perform the above operation according to the markups included in the markup <RESPONSE>.

When the MMB 110 obtains the session ID SID and is to make sure whether the session ID SID is invalidated before logout, the MMB 110 generates and outputs the post-login information PLli. The switch blade 120 receives the post-login information PLli and generates status information STi in response to the post-login information PLli. The MMB 110 can determine whether the session ID SID is invalid according to the status information STi. In the embodiment, the MMB 110 is exemplified to output the post-login information PLli after outputting the login information Lli and before outputting the command information CMDi.

The post-login information PLli includes two columns respectively including the session ID SID and a post-login command. The switch blade 120 determines whether the session ID SID is invalid according to the post-login command and outputs the corresponding status information STi according to the determination result to represent a status of the session ID SID. The following program is an embodiment in which the MMB 110 outputs the post-login information POli and the switch blade 120 outputs the status information STi in response to the post-login information POli.

```
<?xml version=’1.0’?>
<MODULE_POSTLOGIN>
<REQUEST>
    <SID>0xXXXXXXXX</SID>
    <CMDINPUT>...subcommandline...</CMDINPUT>
    <MAXOUTPUTLEN>0x0fff</MAXOUTPUTLEN>
</REQUEST>
</MODULE_POSTLOGIN>
<?xml version=’1.0’?>
<MODULE_POSTLOGIN>
<RESPONSE>
    <OUTPUTLEN>0xXXXX</OUTPUTLEN>
    <STATE>0xXXXXXXXX</STATE>
    <STATENAME>...String...</STATENAME>
    <RC>0x0</RC>
</RESPONSE>
</MODULE_POSTLOGIN>
```

In the embodiment, the basic parameter information BPi, session ID SID, status information STi and execution result Ei have the markup language format for instance. Although the blade server 100 is exemplified to include the MMB 110 and switch blade 120 and the management interface is applied to the series port 130 connecting the MMB 110 and switch blade 120 in the embodiment, the blade server 100 can also include other embedded systems such as server blades 141˜14k, fan modules 151˜15n and power modules 161˜16m, which are respectively connected to each other via different communication connection, wherein k, n, and m are natural number larger than 1. The management interface of the embodiment in not limited to the communication between the MMB 110 and the switch blade 120 and can be further applied to communication between other embedded systems.

For example, the blade server 100 of the embodiment has a MMB 110′ and switch blade 120′ for redundancy in order that when the MMB 110 and the switch blade 120 are broken, the MMB 110′ and switch blade 120′ can perform the required operation instead. The fan modules 152˜15n and the power modules 162˜16m also have the similar design.

Although the MMB 110 is exemplified to subsequently output the inquiry information Ii, login information Lli, post-login information PLli, command information CMDi and logout command LOi to control the switch blade 120 in management interface of the embodiment, the management interface of the embodiment is not limited to the above operational flow and can alter the operational flow according to various usage situations. For example, the MMB 110 can neglect the execution of inquiry information Ii and post-login information PLli or execute twice or more than twice of the above command information CMDi and post-login information PLli.

Although the MMB 110 is exemplified to output the command information CMDi including the control command getipaddr to the switch blade 120 via the management interface to obtain the internet parameter for illustration in the embodiment, the MMB 110 can also output other control commands to control the switch blade 120 via the management interface of the embodiment. For example, the MMB 110 outputs the command information CMDi including the control command setipaddr and a group of preset internet parameters to the switch blade 120 to set the internet parameters of the switch blade 120 to be substantially equal to the preset internet parameters.

In the embodiment, for example, the series port 130 includes software protocols such as point-to-point protocol (PPP) and transmission control/internet protocol (TCP/IP). Therefore, the management interface of the embodiment can transmit information via the software protocols.

The management interface of the embodiment can use a management program of the markup language pattern as a program interface to perform the communication and management between two embedded systems of the blade server. Therefore, the management interface of the embodiment can effectively improve the drawbacks of the conventional blade server which are difficulty of distinguishing the character interface of information, interface disunity and difficulty of developing and maintaining the communication management programs and have the advantages of easier information discrimination, easier maintenance of the communication management programs and interface unification.

Besides, software protocols, such as PPP and TCP/IP can be stacked on the series port for data transmission. Therefore, the management interface of the embodiment can further effectively improve the drawbacks of the conventional blade server which are easy to have transmission faults, such as character missing and character faults, and the mal-operation due to the transmission faults and have the advantages of low transmission fault rate and high operational stability. When the software protocols, such as PPP and TCP/IP, are applied on the series port, software protocols of the application layer even higher than the software protocols TCP, such as secure shell (SSH) and Telnet over Secure Socket Layer (Telnet over SSL) can be applied for providing other convenient internet service.

Furthermore, the management interface with the software protocols includes one of the PPP, TCP/IP, SSH and telnet over SSL can be applied easily on other kind of physical network, such as Ethernet. As a result, the management interface of the embodiment further has the advantages of being capable of providing diverse internet service and flexibly applied on different physical network.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A management interface between embedded systems of a blade server, for executing a management method, the management method comprising:
receiving a login information from a first system and generating a session ID in response to the login information, wherein the login information has a markup language format;
receiving a command information from the first system and sending back an execution result of the command information in response to the command information, wherein the execution result has the markup language format; and
receiving a logout information from the first system and removing the session ID in response to the logout information so as to invalidate the session ID, wherein the logout information has the markup language format.

2. The management interface according to claim 1, wherein a data structure of the login information comprises:
a first column and a second column, respectively comprising a name information and an identification password information corresponding to the name information, wherein a second system determines an operation authority of the first system according to the name information and the identification password information and provides the corresponding session ID.

3. The management interface according to claim 1, wherein a data structure of the command information comprises:
a third column and a fourth column, respectively comprising the session ID and a control command, wherein a second system determines whether the first system has an operation authority to execute the control command according to the session ID, when the first system has the operation authority to execute the control command, and the second system executes the control command and outputs an execution result of the control command.

4. The management interface according to claim 3, wherein the control command is for controlling the second system to output an internet protocol (IP) information to the first system.

5. The management interface according to claim 3, wherein the control command is for revising the IP information of the second system.

6. The management interface according to claim 1, wherein a data structure of the logout information comprises:
a sixth column and a seventh column, respectively comprising the session ID and a logout command, wherein a second system removes the session ID according to the logout command so as to invalidate the session ID.

7. The management interface according to claim 1, further comprising:
receiving a post-login information from the first system and generating a status information in response to the post-login information, wherein the post-login information has the markup language format.

8. The management interface according to claim 7, wherein a data structure of the post-login information comprises:
an eighth column and a ninth column, respectively comprising the session ID and a post-login command, wherein a second system determines whether the session ID is invalid according to the post-login command and outputs the corresponding status information according to a determination result to represent a status of the session ID.

9. The management interface according to claim 1, further comprising:
receiving an inquiry information coded by the markup language from the first system and generating a basis parameter information of a second system in response to the inquiry information.

10. The management interface according to claim 1, wherein the first system is connected to a second system via a communication connection.

11. The management interface according to claim 10, wherein a software layer of the communication connection transmits data via a point-to-point protocol (PPP) and transmission control/internet protocol (TCP/IP).

12. The management interface according to claim 10, wherein a software layer of the communication connection has one of a secure shell (SSH) and a telnet over secure socket layer (SSL).

13. The management interface according to claim 1, wherein the markup language is an extensible markup language (XML).

14. The management interface according to claim 1, wherein the first system is a modular management blade (MMB) and a second system is a switch blade.

15. A computer system medium, having a management interface between embedded systems of a blade server to execute a management method, the management method comprising:
receiving a login information from a first system and generating a session ID in response to the login information, wherein the login information has a markup language format;
receiving a command information from the first system and outputting a device information of a second system corresponding to the command information in response to the command information, wherein the command information has the markup language format; and
receiving a logout information from the first system and removing the session ID in response to the logout information so as to invalidate the session ID, wherein the logout information has the markup language format.

16. The computer system medium according to claim 15, wherein the management method further comprises:
receiving a post-login information from the first system and generating a status information in response to the post-login information, wherein the post-login information has the markup language format.

17. The computer system medium according to claim 15, wherein the management method further comprises:
receiving an inquiry information coded by the markup language from the first system and generating a basis parameter information of the first system in response to the inquiry information.
